(19) United States
(12) Patent Application Publication
(10) Pub. No.: US 2017/0255661 A1
(43) Pub. Date: Sep. 7, 2017

(54) GENERATING AND PLACING LOCATION N-TUPLES IN A NON-DECREASING LOCATION N-TUPLE SEQUENCE

(71) Applicant: Richard Salisbury, Austin, TX (US)

(72) Inventor: Richard Salisbury, Austin, TX (US)

(21) Appl. No.: 15/604,634

(22) Filed: May 24, 2017

Related U.S. Application Data
(63) Continuation-in-part of application No. 14/924,425, filed on Oct. 27, 2015.
Application No. 14/924,425 is a continuation-in-part of application No. 15/263,200, filed on Sep. 12, 2016.
(60) Provisional application No. 62/342,649, filed on May 27, 2016.
(60) Provisional application No. 62/073,128, filed on Oct. 31, 2014.
(60) Provisional application No. 62/083,842, filed on Nov. 24, 2014.
(60) Provisional application No. 62/170,095, filed on Jun. 2, 2015.
(60) Provisional application No. 62/217,826, filed on Sep. 12, 2015.
(60) Provisional application No. 62/249,872, filed on Nov. 2, 2015.
(60) Provisional application No. 62/261,166, filed on Nov. 30, 2015.

(51) Int. Cl. G06F 17/30

(52) U.S. Cl. CPC G06F 17/30333

(57) ABSTRACT

A method of generating a non-decreasing location n-tuple sequence. The method can include obtaining two or more component sequences. The method can also include selecting one of the component sequences as the primary sort-order component sequence. The method can also include populating a locations index for one or more component sequences other than the primary sort-order component sequence. The method can also include adding each locations index to a locations index set. The method can also include creating one or more tier sets. The method can also include creating and initializing a primary sort-order item counter. The method can also include determining whether each locations index in the locations index set contains an associated locations list associated with the primary sort-order cursor item. The method can also include determining whether the locations index set contains more than one locations index when each locations index in the locations index set contains an associated locations list associated with the primary sort-order cursor item. The method can also include selecting one of the associated locations lists as the increasing component value locations list when the locations index set contains more than one locations index. The method can also include identifying one or more permutations that may be generated by selecting other locations list entries from the other locations lists, together with the entries in the increasing component value locations list taken successively one at a time. The method can also include selecting the sole associated locations list as the increasing component value locations list when the locations index set does not contain more than one locations index. The method can also include identifying one or more permutations that may be generated by selecting the entries from the increasing component value locations list taken successively one at a time. The method can also include adding the entries in each identified permutation to a newly-created primary sort-order non-decreasing location n-tuple. The method can also include adding the current value of the primary sort-order item counter to each primary sort-order non-decreasing location n-tuple. The method can also include placing one or more of the primary sort-order non-decreasing location n-tuples into one or more of the tier sets. The method can also include determining whether all possible primary sort-order non-decreasing location n-tuples have been generated. The method can also include adjusting the primary sort-order item counter.

### CROSS-REFERENCE TO RELATED APPLICATIONS

This application claims the benefit of and priority to U.S. Provisional Patent Application Ser. No. 62/342,649 filed on May 27, 2016, which application is incorporated herein by reference in its entirety.

This application is a continuation-in-part of, and claims the benefit of and priority to, U.S. patent application Ser. No. 14/924,425 filed on Oct. 27, 2015, which application is incorporated herein by reference in its entirety.

U.S. Non-Provisional patent application Ser. No. 14/924,425 claims the benefit of and priority to U.S. Provisional Patent Application Ser. No. 62/073,128 filed on Oct. 31, 2014, which application is incorporated herein by reference in its entirety.

U.S. Non-Provisional patent application Ser. No. 14/924,425 claims the benefit of and priority to U.S. Provisional Patent Application Ser. No. 62/083,842 filed on Nov. 24, 2014, which application is incorporated herein by reference in its entirety.

U.S. Non-Provisional patent application Ser. No. 14/924,425 claims the benefit of and priority to U.S. Provisional Patent Application Ser. No. 62/170,095 filed on Jun. 2, 2015, which application is incorporated herein by reference in its entirety.

This application is a continuation-in-part of, and claims the benefit of and priority to, U.S. patent application Ser. No. 15/263,200 filed on Sep. 12, 2016, which application is incorporated herein by reference in its entirety.

U.S. Non-Provisional patent application Ser. No. 15/263,200 claims the benefit of and priority to U.S. Provisional Patent Application Ser. No. 62/217,826 filed on Sep. 12, 2015, which application is incorporated herein by reference in its entirety.

U.S. Non-Provisional patent application Ser. No. 15/263,200 claims the benefit of and priority to U.S. Provisional Patent Application Ser. No. 62/249,872 filed on Nov. 2, 2015, which application is incorporated herein by reference in its entirety.

U.S. Non-Provisional patent application Ser. No. 15/263,200 claims the benefit of and priority to U.S. Provisional Patent Application Ser. No. 62/261,166 filed on Nov. 30, 2015, which application is incorporated herein by reference in its entirety.

### BACKGROUND OF THE INVENTION

U.S. patent application Ser. No. 14/924,425 (“application Ser. No. 14/924,425”) teaches means for (inter alia) obtaining two or more component sequences, generating one or more location n-tuples with respect to commonly-occurring items within the component sequences, correctly placing one or more location n-tuples into a tier in a tier set, and using the tier set to identify certain common subsequences among the component sequences.

Although this may be implemented in multiple different manners, not all implementations are equally efficient. A particularly inefficient implementation might require serial inspection of each generated location n-tuple to determine the correct placement tier for each such location n-tuple.

Accordingly, there is a need in the art for efficient means for identifying the correct placement tier for each location n-tuple in a sequence of location n-tuples by inspection of potentially fewer than each of the location n-tuples in the sequence.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of generating a non-decreasing location n-tuple sequence. The method can include obtaining two or more component sequences. The method can also include selecting one of the component sequences as the primary sort-order component sequence. The method can also include populating a locations index for one or more component sequences other than the primary sort-order component sequence. The method can also include adding each locations index to a locations index set. The method can also include creating one or more tier sets. The method can also include creating and initializing a primary sort-order item counter. The method can also include determining whether each locations index in the locations index set contains an associated locations list associated with the primary sort-order cursor item. The method can also include determining whether the locations index set contains more than one locations index when each locations index in the locations index set contains an associated locations list associated with the primary sort-order cursor item. The method can also include selecting one of the associated locations lists as the increasing component value locations list when the locations index set contains more than one locations index. The method can also include identifying one or more permutations that may be generated by selecting other locations list entries from the other locations lists, together with the entries in the increasing component value locations list taken successively one at a time. The method can also include selecting the sole associated locations list as the increasing component value locations list when the locations index set does not contain more than one locations index. The method can also include identifying one or more permutations that may be generated by selecting the entries from the increasing component value locations list taken successively one at a time. The method can also include adding the entries in each identified permutation to a newly-created primary sort-order non-decreasing location n-tuple. The method can also include adding the current value of the primary sort-order item counter to each primary sort-order non-decreasing location n-tuple. The method can also include placing one or more of the primary sort-order non-decreasing location n-tuples into one or more of the tier sets. The method can also include determining whether all possible primary sort-order non-decreasing location n-tuples have been generated. The method can also include adjusting the primary sort-order item counter.

Another example embodiment includes a method of placing one or more location n-tuples in a non-decreasing location n-tuple sequence into a tier set. The method can include determining whether the tier set is empty. The method can also include creating a new tier, placing each of the location n-tuples in the non-decreasing location n-tuple sequence into the newly-created tier and adding the newly-created tier to the tier set when the tier set is empty. The method can also include determining whether an upper bounding tier exists in the tier set when the tier set is not empty. The method can also include placing each location n-tuple in the non-decreasing location n-tuple sequence into the first-created tier when no upper bounding tier exists in the tier set. The method can also include creating a rising tier counter when an upper bounding tier exists in the tier set. The method can also include determining whether a lower bounding tier exists in the tier set. The method can also include nulling the rising tier counter when a lower bounding tier does not exist in the tier set. The method can also include adjusting the rising tier counter so that it references the lower bounding tier when a lower bounding tier exists in the tier set. The method can also include creating a sequence location n-tuple counter and initializing it to reference the first location n-tuple in the non-decreasing location n-tuple sequence. The method can also include determining whether the current value of the rising tier counter references the upper bounding tier. The method can also include determining whether the upper bounding tier is the most recently created tier in the tier set when the current value of the rising tier counter references the upper bounding tier. The method can also include creating a new tier, placing the sequence current location n-tuple and each subsequent location n-tuple in the non-decreasing location n-tuple sequence into the newly-created tier and adding the newly-created tier to the tier set when the upper bounding tier is the most recently created compactable tier in the compactable tier set. The method can also include placing the sequence current location n-tuple and each subsequent location n-tuple in the non-decreasing location n-tuple sequence into the tier that was added to the tier set immediately after the tier referenced by the rising tier counter when the upper bounding tier is not the most recently created tier in the tier set. The method can also include identifying a sequence next location n-tuple and a sequence next predicate tier. The method can also include determining whether the current value of the rising tier counter is a null value. The method can also include placing the sequence current location n-tuple and each location n-tuple between the sequence current location n-tuple and the sequence next location n-tuple in the non-decreasing location n-tuple sequence into the first-created tier when the current value of the rising tier counter is a null value. The method can also include placing the sequence current location n-tuple and each location n-tuple between the sequence current location n-tuple and the sequence next location n-tuple in the non-decreasing location n-tuple sequence into the tier that added to the tier set immediately after the tier referenced by the rising tier counter when the current value of the rising tier counter is not a null value. The method can also include adjusting the sequence location n-tuple counter so that it references the sequence next location n-tuple. The method can also include adjusting the rising tier counter so that it references the sequence next predicate tier.

Another example embodiment includes a method of placing one or more location n-tuples in a non-decreasing location n-tuple sequence into a compactable tier set. The method can include determining whether the compactable tier set is empty. The method can also include creating a new compactable tier, placing the first location n-tuple in the non-decreasing location n-tuple sequence into the newly-created compactable tier and adding the newly-created compactable tier to the compactable tier set when the compactable tier set is empty. The method can also include determining whether an upper bounding tier exists in the compactable tier set when the compactable tier set is not empty. The method can also include attempting to place the first location n-tuple in the non-decreasing location n-tuple sequence into the first-created compactable tier when an upper bounding tier does not exist in the compactable tier set. The method can also include creating a rising tier counter when an upper bounding tier exists in the compactable tier set. The method can also include determining whether a lower bounding tier exists in the compactable tier set. The method can also include nulling the rising tier counter when a lower bounding tier does not exist in the compactable tier set. The method can also include adjusting the rising tier counter so that it references the lower bounding tier when a lower bounding tier exists in the compactable tier set. The method can also include creating a sequence location n-tuple counter and initializing it to reference the first location n-tuple in the non-decreasing location n-tuple sequence. The method can also include determining whether the current value of the rising tier counter references the upper bounding tier. The method can also include determining whether the upper bounding tier is the most recently created compactable tier in the compactable tier set when the current value of the rising tier counter references the upper bounding tier. The method can also include creating a new compactable tier, placing the sequence current location n-tuple into the newly-created compactable tier and adding the newly-created compactable tier to the compactable tier set when the upper bounding tier is the most recently created compactable tier in the compactable tier set. The method can also include attempting to place the sequence current location n-tuple into the compactable tier that was added to the compactable tier set immediately after the compactable tier referenced by the rising tier counter when the upper bounding tier is not the most recently created compactable tier in the compactable tier set. The method can also include identifying a sequence next location n-tuple and a sequence next predicate tier. The method can also include determining whether the current value of the rising tier counter is a null value. The method can also include attempting to place the sequence current location n-tuple into the first-created compactable tier when the current value of the rising tier counter is a null value. The method can also include attempting to place the sequence current location n-tuple into the compactable tier that was added to the compactable tier set immediately after the compactable tier referenced by the rising tier counter when the current value of the rising tier counter is not a null value. The method can also include adjusting the sequence location n-tuple counter so that it references the sequence next location n-tuple. The method can also include adjusting the rising tier counter so that it references the sequence next predicate tier.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of generating a non-decreasing location n-tuple sequence.

FIG. 2 is a flowchart illustrating a method of placing one or more location n-tuples in a non-decreasing location n-tuple sequence into a tier set.

FIG. 3 is a flowchart illustrating a method of placing one or more location n-tuples in a non-decreasing location n-tuple sequence into a compactable tier set; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale. Unless otherwise specifically noted, terms defined in application Ser. No. 14/924,425 or U.S. patent application Ser. No. 15/263,200 (“application Ser. No. 15/263,200”), respectively, have the same meanings when used herein.

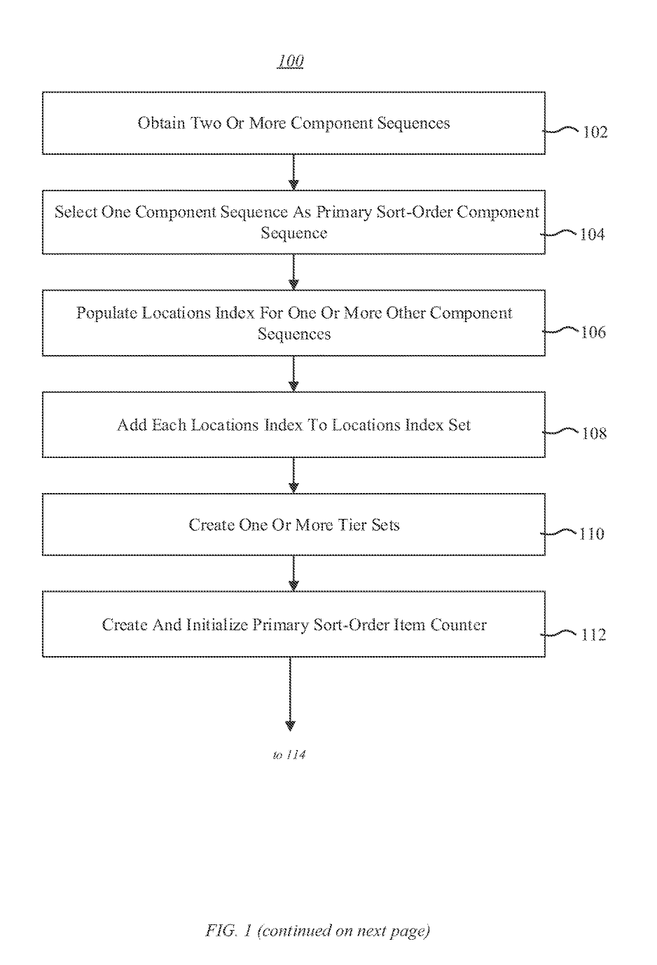

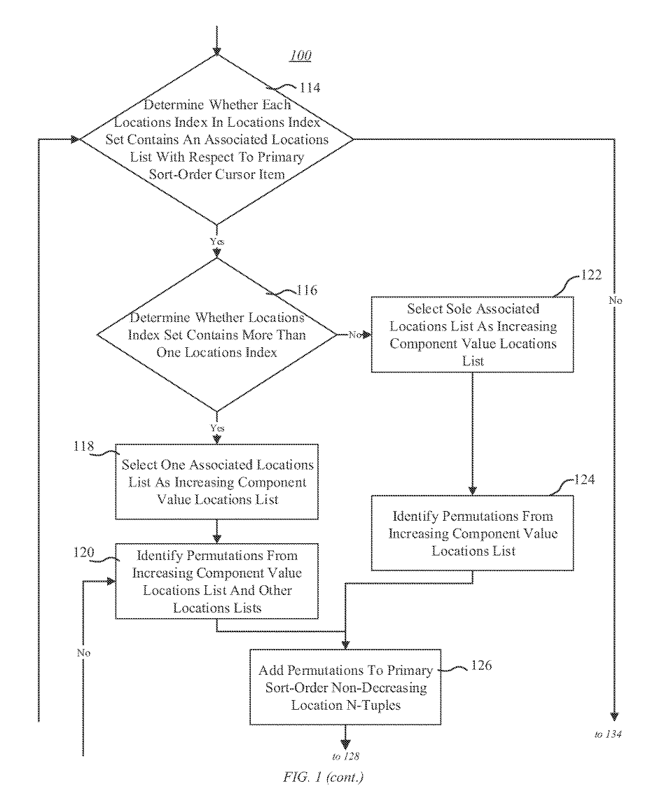

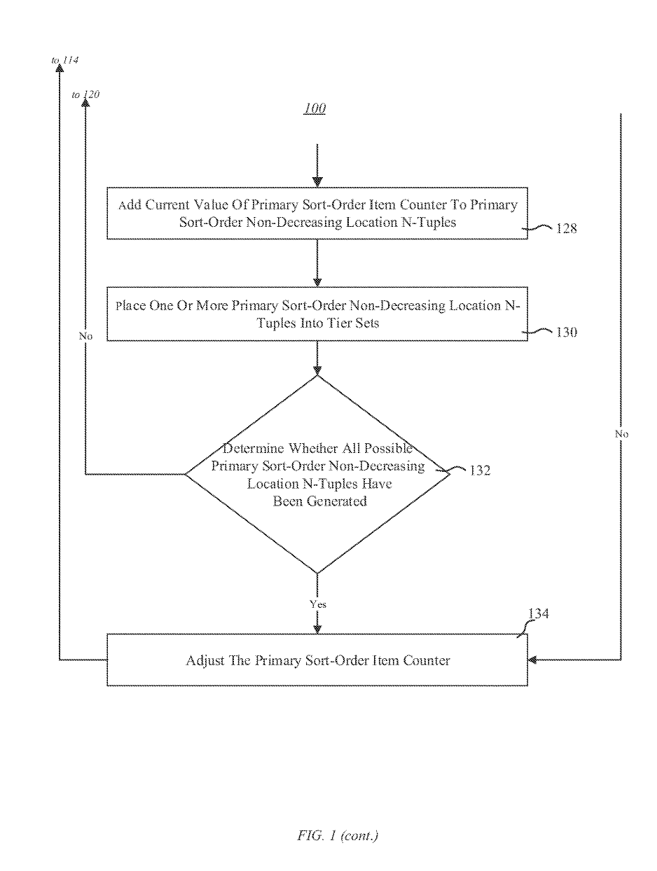

FIG. 1 is a flowchart illustrating a method 100 of generating a non-decreasing location n-tuple sequence. A “non-decreasing location n-tuple sequence” is defined as a sequence of location n-tuples wherein each location n-tuple in the sequence satisfies the conditions that it is: (i) smaller than or equal to each location n-tuple subsequent to it in the sequence, and (ii) larger than or equal to each location n-tuple prior to it in the sequence.

A location n-tuple is “smaller than or equal to” another location n-tuple if each of the component values in the first location n-tuple are smaller than or equal to the corresponding component values in the second location n-tuple. For example, location n-tuple {0, 0, 0} is smaller than or equal to location n-tuple {1, 0, 0} because 0<1, 0=0 and 0=0. By contrast, location n-tuple {0, 0, 1} is not smaller than or equal to location n-tuple {1, 0, 0} because 0<1 and 0=0, but 1>0.

A location n-tuple is “larger than or equal to” another location n-tuple if each of the component values in the first location n-tuple are larger than or equal to the corresponding component values in the second location n-tuple. For example, location n-tuple {1, 0, 0} is larger than or equal to location n-tuple {0, 0, 0} because 1>0, 0=0 and 0=0. By contrast, location n-tuple {1, 0, 0} is not larger than or equal to location n-tuple {0, 0, 1} because 1>0 and 0=0, but 0<1.

For example, the following sequence of location n-tuples constitutes a non-decreasing location n-tuple sequence:
{{0, 0, 0}, {1, 0, 0}, {2, 0, 0}, {3, 0, 0}}

By contrast, the following sequence of location n-tuples does not constitute a non-decreasing location n-tuple sequence:
{{0, 0, 0}, {1, 0, 0}, {3, 0, 0}, {2, 0, 0}}

Each location n-tuple in a non-decreasing location n-tuple sequence other than the first and last location n-tuples is bounded by at least one smaller than or equal to location n-tuple (each a “lower bounding location n-tuple”) and at least one larger than or equal to location n-tuple (each an “upper bounding location n-tuple”). The first location n-tuple in a non-decreasing location n-tuple sequence of length greater than 1 is bounded by at least one upper bounding location n-tuple. The last location n-tuple in a non-decreasing location n-tuple sequence of length greater than 1 is bounded by at least one lower bounding location n-tuple. Thus, each location n-tuple in a non-decreasing location n-tuple sequence of length greater than 1 is bounded by at least one lower bounding location n-tuple and/or one upper bounding location n-tuple (the “location n-tuple boundedness property”).

With respect to a location n-tuple in a non-decreasing location n-tuple sequence, the set of one or more lower bounding location n-tuples and/or upper bounding location n-tuples applicable to the location n-tuple are referred to as “bounding location n-tuples” and the location n-tuple, when described in relation to its bounding location n-tuples, is referred to as the “bounded location n-tuple.”

FIG. 1 shows that the method 100 can include obtaining 102 two or more component sequences.

FIG. 1 shows that the method 100 can also include selecting 104 one of the component sequences as the primary sort-order component sequence.

FIG. 1 shows that the method 100 can also include populating 106 a locations index for one or more component sequences other than the primary sort-order component sequence.

FIG. 1 shows that the method 100 can also include adding 108 each locations index to a locations index set.

FIG. 1 shows that the method 100 can also include creating 110 one or more tier sets.

FIG. 1 shows that the method 100 can also include creating 112 and initializing a primary sort-order item counter.

FIG. 1 shows that the method 100 can also include determining 114 whether each locations index in the locations index set contains an associated locations list associated with the item in the primary sort-order component sequence that is referenced by the current value of the primary sort-order item counter (the “primary sort-order cursor item”)—i.e., the current item.

FIG. 1 shows that the method 100 can also include determining 116 whether the locations index set contains more than one locations index when each locations index in the locations index set contains an associated locations list associated with the primary sort-order cursor item.

FIG. 1 shows that the method 100 can also include selecting 118 one of the associated locations lists as the increasing component value locations list when the locations index set contains more than one locations index. An “increasing component value locations list” is a locations list that supplies a component value that increases between and among the location n-tuples in the non-decreasing location n-tuple sequence.

For example, consider the following non-decreasing location n-tuple sequence: {{0, 0, 0}, {0, 0, 1}, {0, 0, 2}, {0, 0, 3}}. The third component value (index 2) increases between and among the location n-tuples in this sequence. Consequently, the locations list that supplies the third component value is an increasing component value locations list in this example.

FIG. 1 shows that the method 100 can also include identifying 120 one or more permutations that may be generated by selecting exactly one entry from each of the associated locations lists other than the increasing component value locations list (each an “other locations list entry”), together with the entries in the increasing component value locations list taken successively one at a time.

For example, assume that it was determined 114 that each locations index in the locations index set contains an associated locations list associated with the primary sort-order cursor item as follows (“Example associated locations lists 1”):
{{0, 5}, {0, 4}, {0, 2, 4, 5, 6}}

Assume also that the third of these associated locations lists is selected 118 as the increasing component value locations list and that the first entries in the other associated locations lists are selected as the other locations list entries. The following permutations may be identified 120:
{{0, 0, 0}, {0, 0, 2}, {0, 0, 4}, {0, 0, 5}, {0, 0, 6}}

FIG. 1 shows that the method 100 can also include selecting 122 the sole associated locations list as the increasing component value locations list when the locations index set does not contain more than one locations index. If the locations index set contains exactly one locations index, the associated locations list contained therein must necessarily be selected as the increasing component value locations list.

FIG. 1 shows that the method 100 can also include identifying 124 one or more permutations that may be generated by selecting the entries from the increasing component value locations list taken successively one at a time. If the sole associated locations list was selected 122 as the increasing component value locations list, then there are no other associated locations lists and hence no other locations list entries. Consequently, the only permutations that will be identified 124 comprise the individual entries in the increasing component value locations list taken successively one at a time.

FIG. 1 shows that the method 100 can also include adding 126 the entries in each identified permutation to a newly-created location n-tuple (each a “primary sort-order non-decreasing location n-tuple”).

FIG. 1 shows that the method 100 can also include adding 128 the current value of the primary sort-order item counter to each primary sort-order non-decreasing location n-tuple.

FIG. 1 shows that the method 100 can also include placing 130 one or more of the primary sort-order non-decreasing location n-tuples into one or more of the tier sets. Importantly, the efficiency of this process can be improved because these location n-tuples constitute a non-decreasing location n-tuple sequence and the location n-tuple boundedness property therefore applies.

Bounding location n-tuples can increase the efficiency of the process for determining the correct placement tier in a tier set (which can include a potential placement compactable tier in a compactable tier set) for one or more bounded location n-tuples due to the location n-tuple boundedness property and the nature of the process for determining the placement tier. The latter is described in greater detail in application Ser. No. 14/924,425 and application Ser. No. 15/263,200, both previously incorporated. It can include (inter alia) attempting to identify the most recently created tier in the tier set (which can include a compactable tier in a compactable tier set) containing a location n-tuple that is unambiguously smaller than the location n-tuple to be placed (a “placement predicate tier”).

The placement predicate tier for a bounded location n-tuple is itself bounded by the placement predicate tiers for its bounding location n-tuples (the “placement predicate tier boundedness property”). Specifically, the placement predicate tier for a bounded location n-tuple must necessarily be: (i) the same tier that is also the placement predicate tier for one or more of its lower bounding location n-tuples; or (ii) a tier that was added to the tier set after the tier that is the placement predicate tier for one or more of its lower bounding location n-tuples. Similarly, the placement predicate tier for a bounded location n-tuple must necessarily also be: (i) the same tier that is also the placement predicate tier for one or more of its upper bounding location n-tuples; or (ii) a tier that was added to the tier set before the tier that is the placement predicate tier for one or more of its upper bounding location n-tuples.

Notationally, this can be explained as follows. Assume a lower bounding location n-tuple {x′₀, x′₁, . . . x′ₙ} and a bounded location n-tuple {x″₀, x″₁, . . . x″ₙ} in a non-decreasing location n-tuple sequence. Thus, {x′₀, x′₁, . . . x′ₙ}≦{x″₀, x″₁, . . . x″ₙ} where the ≦operator signifies that x′₀≦x″₀, x′₁≦x″₁, . . . x′ₙ≦x″ₙ. Assume also that tier[m] is the placement predicate tier for {x′₀, x′₁, . . . x′ₙ} and therefore contains an unambiguously smaller location n-tuple {x₀, x₁, . . . x_{n,}} such that {x₀, x₁, . . . xₙ}<{x′₀, x′₁, . . . x′ₙ}, where the <operator signifies that x₀<x′₀, x₁<x′₁, . . . xₙ<x′ₙ. Because {x₀, x₁, . . . xₙ}<{x′₀, x′₁, . . . x′ₙ}≦{x′₀, x″₁, . . . x″ₙ} [symbol] {x₀, x₁, . . . xₙ}<{x″₀, x″₁, . . . x″ₙ}, either tier[m] or a more recently created tier must be the placement predicate tier for {x″₀, x″₁, . . . x″ₙ}.

A similar analysis applies to the upper bounding location n-tuples of a bounded location n-tuple. Because any location n-tuple that is unambiguously smaller than the bounded location n-tuple must necessarily also be unambiguously smaller than each of its upper bounding location n-tuples, the placement predicate tier for each of its upper bounding location n-tuples must be either: (i) the same tier that is the placement predicate tier for the bounded location n-tuple; or (ii) a tier that was added to the tier set after the tier that is the placement predicate tier for the bounded location n-tuple. This same proposition may be restated by reference to the bounded location n-tuple to state that the placement predicate tier for a bounded location n-tuple must necessarily be: (i) the same tier that is also placement predicate tier for one or more of its upper bounding location n-tuples; or (ii) a tier that was added to the tier set before the tier that is the placement predicate tier for one or more of its upper bounding location n-tuples.

One important consequence of the placement predicate tier boundedness property is that if the placement predicate tier for the first location n-tuple in a non- decreasing location n-tuple sequence is the same as the placement predicate tier for the last location n-tuple in the sequence, this tier must necessarily also be the placement predicate tier for each of the other location n-tuples between the first and last location n-tuples in the sequence. Stated more generally, whenever two location n-tuples in a non-decreasing location n-tuple sequence share the same placement predicate tier, this must necessarily also be the placement predicate tier for each of the location n-tuples (if any) that occur between the two location n-tuples in the sequence (the “placement predicate tier sandwich property”). A subsequence as to which the placement predicate tier sandwich property applies is referred to as a “sandwiched subsequence.”

Another important consequence of the placement predicate tier boundedness property is that the sequence of corresponding placement predicate tiers for each of the location n-tuples in the non-decreasing location n-tuple sequence is in monotonically non-decreasing order (the “monotonically non-decreasing tier property”). A sequence of placement predicate tiers with respect to a non-decreasing location n-tuple sequence is in “monotonically non-decreasing order” if each tier in the sequence satisfies the conditions that it is: (i) either the same tier as, or a tier added to the tier set after, each tier prior to it in the sequence; and (ii) either the same tier as, or a tier added to the tier set before, each tier subsequent to it in the sequence.

For example, consider a non-decreasing location n-tuple sequence comprising the following location n-tuples: {{x₀, x₁, . . . xₙ}, {x′₀, x′₁, . . . x′ₙ}, {x″₀, x″₁, . . . x″ₙ}, {x′″₀, x′″₁, . . . x′″ₙ}}. By the definition of a non-decreasing location n-tuple sequence, {x₀, x₁, . . . x_{n,}}≦{x′₀, x′₁, . . . x′ₙ}≦{x″₀, x″₁, . . . x″ₙ}≦{x′″₀, x′″₁, . . . x′″ₙ}. The monotonically non-decreasing tier property guarantees that Tier_{PP}({x₀, x₁, . . . x_{n,}})≦Tier_{PP}({x′₀, x′₁, . . . x′ₙ})≦Tier_{PP}({x″₀, x″₁, . . . x″ₙ})≦Tier_{PP}({x′″₀, x′″₁, . . . x′″ₙ}) where Tier_{PP}( ) represents a function that returns the placement predicate tier for the location n-tuple supplied as an input and the <operator signifies that the left-hand side tier is either the same tier as, or was added to the tier set before, the right-hand side tier.

FIG. 1 shows that the method 100 can also include determining 132 whether all possible primary sort-order non-decreasing location n-tuples have been generated. This includes determining whether every possible permutation of the other locations list entries (if any) and the entries in the increasing component value locations list has been identified. If additional such permutations remain to be identified, additional distinct primary sort-order non-decreasing location n-tuples may yet be generated.

Steps 120 and 126-130 may be successively repeated for different permutations of other locations list entries. For instance, considering again Example associated locations lists 1 and assuming that the third associated location list is the increasing component value locations list, that the first entries in the other locations lists are selected as the other locations list entries, that the primary sort-order component value is the first component value (index 0) and that the current value of the primary sort-order counter is 0, the following primary sort-order non-decreasing location n-tuples will be generated at steps 120 and 126-128:
{{0, 0, 0, 0}, {0, 0, 0, 2}, {0, 0, 0, 4}, {0, 0, 0, 5}, {0, 0, 0, 6}}

Now assume the same premises except that the second entry in the second other locations list is selected for the other locations list entries. When steps 120 and 126-128 are repeated using these assumptions, the following primary sort-order non-decreasing location n-tuples will now be generated:
{{0, 0, 4, 0}, {0, 0, 4, 2}, {0, 0, 4, 4}, {0, 0, 4, 5}, {0, 0, 4, 6}}

Steps 120 and 126-130 may be repeated, as desired, until all possible primary sort-order non-decreasing location n-tuples have been generated.

By contrast, if the sole associated locations list was selected 122 as the increasing component value locations list, there are no other associated locations lists and hence no other locations list entries. Consequently, it is unnecessary to repeat steps 124-130 because a single iteration will identify all possible permutations and generate all distinct primary sort-order non-decreasing location n-tuples.

For example, assume that the following sole associated locations list was selected 122 as the increasing component value locations list: {0, 2, 4, 5, 6}. Assuming also that the primary sort-order component value is the first component value (index 0) and that the current value of the primary sort-order counter is 0, the following primary sort-order non-decreasing location n-tuples will be generated at 124-128: {{0, 0}, {0, 2}, {0, 4}, {0, 5}, {0, 6}}

Repetition of steps 124-130 is unnecessary because it will not generate any additional distinct primary sort-order non-decreasing location n-tuples.

FIG. 1 shows that the method 100 can include adjusting 134 the primary sort-order item counter. The steps 114-134 may be successively repeated for each item in the primary sort-order component sequence.

The following example is provided for illustrative purposes only and without intent or effect to limit the scope of the invention. It does not purport to illustrate all of the steps (either required or optional) nor every sub-part of, nor every state nor condition applicable to, those steps (either required or optional) illustrated.

Assume four component sequences, S1, S2, S3 and S4 as follows:
S1: {A, B, C, D, E, A, X}
S2: {A, B, C, D, E, A, Y}
S3: {A, B, C, D, A, E, Z}
S4: {A, B, A, C, A, A, A}

Assume that at 104, S1 is selected as the primary sort-order component sequence. After a locations index is populated is populated 106 for S2, S3 and S4 and each locations index is added 108 to the locations index set, the locations index set might be depicted as follows:

| Item | S2 Locations | S3 Locations | S4 Locations |
|---|---|---|---|
| A | {0, 5} | {0, 4} | {0, 2, 4, 5, 6} |
| B | {1} | {1} | {1} |
| C | {2} | {2} | {3} |
| D | {3} | {3} | { } |
| E | {4} | {5} | { } |
| X | { } | { } | { } |
| Y | {6} | { } | { } |
| Z | { } | {6} | { } |

A tier set is created 110. At 112, the primary sort-order item counter is created and initialized to some desired value (which is assumed for purposes of this example to be zero). At the first iteration of 114, the first item in S1 (A) is the primary sort order cursor item.

It is determined 114 that each locations index in the locations index set contains an associated locations list associated with the primary sort-order cursor item. It is also determined 116 that the locations index set contains more than one locations index. Assume that the associated locations list associated with S4 is selected 118 as the increasing component value locations list. If the first entries in the associated locations lists associated with S2 and S3 are selected as the other locations list entries at 120, the following primary sort-order location n-tuples are generated at 126-128:
{{0, 0, 0, 0}, {0, 0, 0, 2}, {0, 0, 0, 4}, {0, 0, 0, 5}, {0, 0, 0, 6}}

At 130, these primary sort-order non-decreasing location n-tuples are placed into the tier set.

Because it is determined 132 that not all possible primary sort-order non-decreasing location n-tuples have been generated, steps 120 and 126-130 will be repeated. Assuming that upon the next iteration of step 120, the first entry in the associated location list associated with S2 and the second entry in the associated location list associated with S3 are selected as the other locations list entries, the following primary sort-order non-decreasing location n-tuples are generated at 126-128:
{{0, 0, 4, 0}, {0, 0, 4, 2}, {0, 0, 4, 4}, {0, 0, 4, 5}, {0, 0, 4, 6}}

At 130, these primary sort-order non-decreasing location n-tuples are placed into the tier set.

Because it is determined 132 that not all possible primary sort-order non-decreasing location n-tuples have been generated, steps 120 and 126-130 will be repeated. Assuming that upon the next iteration of step 120, the second entry in the associated location list associated with S2 and the first entry in the associated location list associated with S3 are selected as the other locations list entries, the following primary sort-order non-decreasing location n-tuples are generated at 126-128:
{{0, 5, 0, 0}, {0, 5, 0, 2}, {0, 5, 0, 4}, {0, 5, 0, 5}, {0, 5, 0, 6}}

At 130, these primary sort-order non-decreasing location n-tuples are placed into the tier set.

Because it is determined 132 that not all possible primary sort-order non-decreasing location n-tuples have been generated, steps 120 and 126-130 will be repeated. Assuming that upon the next iteration of step 120, the second entry in the associated location list associated with S2 and the second entry in the associated location list associated with S3 are selected as the other locations list entries, the following primary sort-order non-decreasing location n-tuples are generated at 126-128:
{{0, 5, 4, 0}, {0, 5, 4, 2}, {0, 5, 4, 4}, {0, 5, 4, 5}, {0, 5, 4, 6}}

At 130, these primary sort-order non-decreasing location n-tuples are placed into the tier set.

Because it is determined 132 that all possible primary sort-order non-decreasing location n-tuples have been generated, steps 120 and 126-130 will be not be further repeated.

The primary sort-order item counter is then adjusted 134.

Additional iterations of steps 114-134 are not illustrated for purposes of this example.

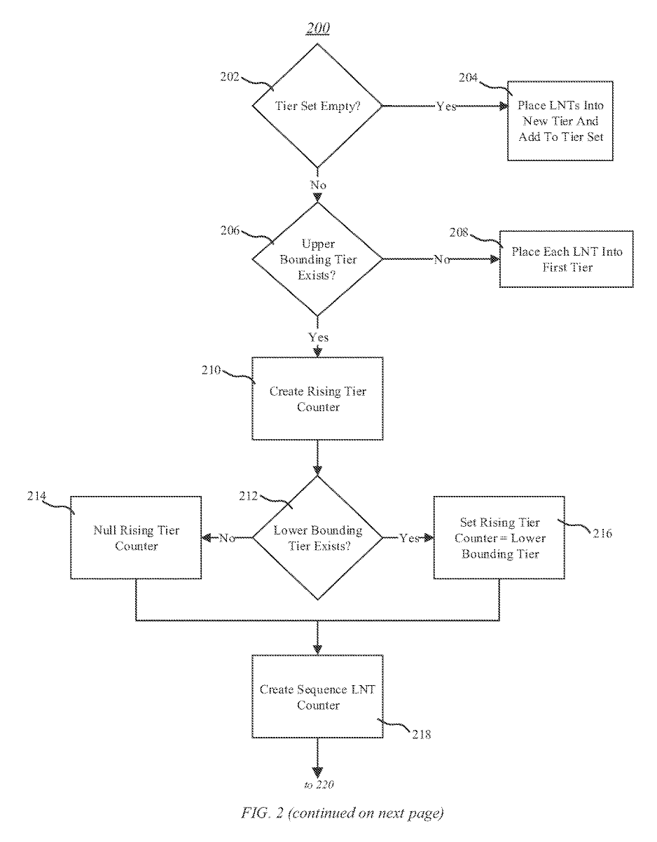

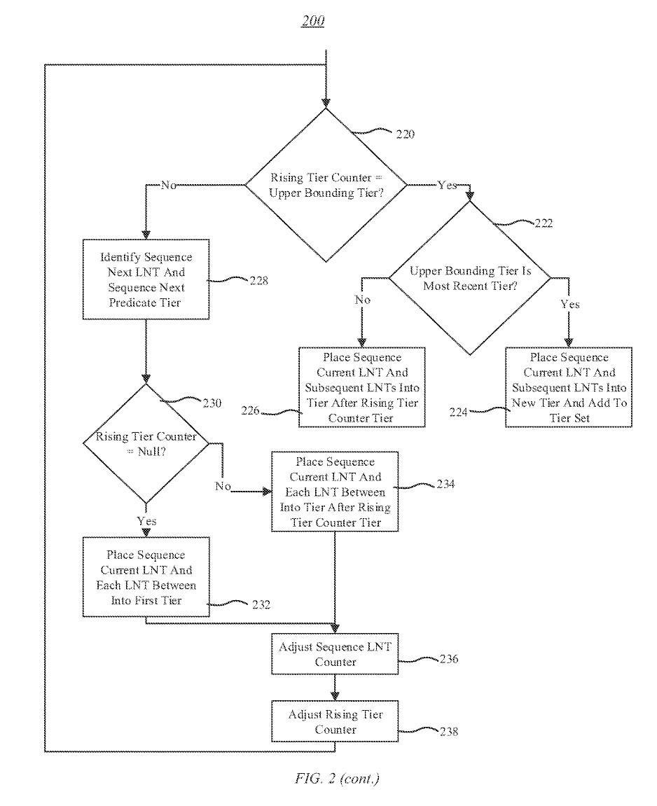

FIG. 2 is a flowchart illustrating a method 200 of placing one or more location n-tuples in a non-decreasing location n-tuple sequence into a tier set.

FIG. 2 shows that the method 200 can include determining 202 whether the tier set is empty.

FIG. 2 shows that the method 200 can also include creating 204 a new tier, placing each of the location n-tuples in the non-decreasing location n-tuple sequence into the newly-created tier and adding the newly-created tier to the tier set when the tier set is empty.

FIG. 2 shows that the method 200 can also include determining 206 whether an upper bounding tier exists in the tier set when the tier set is not empty. An “upper bounding tier” is defined as the placement predicate tier for the last location n-tuple in a non-decreasing location n-tuple sequence. If no upper bounding tier exists in the tier set, this means that no tier in the tier set contains a location n-tuple that is unambiguously smaller than the last location n-tuple in the non-decreasing location n-tuple sequence. Because of the placement predicate tier boundedness property, this also necessarily means that no tier in the tier set contains a location n-tuple that is unambiguously smaller than any of the location n-tuples in the sequence. Consequently, the correct placement tier in the tier set for each of the location n-tuples in the sequence is the first-created tier.

FIG. 2 shows that the method 200 can also include placing 208 each location n-tuple in the non-decreasing location n-tuple sequence into the first-created tier when no upper bounding tier exists in the tier set.

FIG. 2 shows that the method 200 can also include creating 210 a tier counter (the “rising tier counter”) when an upper bounding tier exists in the tier set. A “tier counter” is a combination of computer storage capable of storing a reference to a particular tier within a tier set (which can include a compactable tier within a compactable tier set). Such a tier counter may be initialized so that it references a particular tier within the tier set and may thereafter be adjusted so that it references another tier that was added to the tier set either before or after the initially-referenced tier. To “reference” a tier means to uniquely and specifically identify the tier within the tier set (which can include use of a count, offset value or pointer). A tier counter may also be adjusted with a null value such that it does not reference any of the tiers within the tier set.

FIG. 2 shows that the method 200 can also include determining 212 whether a lower bounding tier exists in the tier set. A “lower bounding tier” is defined as the placement predicate tier for the first location n-tuple in a non-decreasing location n-tuple sequence.

FIG. 2 shows that the method 200 can also include nulling 214 the rising tier counter when a lower bounding tier does not exist in the tier set. To “null” a tier counter means to adjust it with a null value such that it does not reference any of the tiers within a tier set.

FIG. 2 shows that the method 200 can also include adjusting 216 the rising tier counter so that it references the lower bounding tier when a lower bounding tier exists in the tier set.

Because of the placement predicate tier boundedness property, the placement predicate tier for each of the location n-tuples in the non-decreasing location n-tuple sequence must necessarily be one of the following: (i) the upper bounding tier, or (ii) a tier that was added to the tier set before the upper bounding tier. If a lower bounding tier exists, the placement predicate tier for each of the location n-tuples in the non-decreasing location n-tuple sequence is further constrained in that it must necessarily be one of the following: (i) the lower bounding tier, (ii) the upper bounding tier, or (iii) a tier that was added to the tier set after the lower bounding tier and before the upper bounding tier.

Thus, only this relevant subset of tiers (which may comprise only a small portion of the total number of tiers in the tier set) need be considered as potential placement predicate tiers. Other tiers in the tier set need not be inspected or otherwise considered.

FIG. 2 shows that the method 200 can also include creating 218 a location n-tuple counter (the “sequence location n-tuple counter”) and initializing it to reference the first location n-tuple in the non-decreasing location n-tuple sequence. A “location n-tuple counter” means a combination of computer storage capable of storing a reference to a location n-tuple within a group of location n-tuples (which can include a group of location n-tuples in a sequence or a group of location n-tuples in a tier). Such a location n-tuple counter may be initialized so that it references a particular location n-tuple within the group and may thereafter be adjusted so that it references a different location n-tuple within the group. To “reference” a location n-tuple means to uniquely and specifically identify the location n-tuple within a group of location n-tuples (which can include use of a count, offset value or pointer).

FIG. 2 shows that the method 200 can also include determining 220 whether the current value of the rising tier counter references the upper bounding tier. The steps 220-238 are repeated (as applicable) until it is determined 220 that the current value of the rising tier counter references the upper bounding tier. For each iteration, the location n-tuple referenced by the current value of the sequence location n-tuple counter during such iteration is referred to as the “sequence current location n-tuple.”

FIG. 2 shows that the method 200 can also include determining 222 whether the upper bounding tier is the most recently created tier in the tier set when the current value of the rising tier counter references the upper bounding tier.

FIG. 2 shows that the method 200 can also include creating 224 a new tier, placing the sequence current location n-tuple and each subsequent location n-tuple in the non-decreasing location n-tuple sequence into the newly-created tier and adding the newly-created tier to the tier set when the upper bounding tier is the most recently created tier in the tier set.

FIG. 2 shows that the method 200 can also include placing 226 the sequence current location n-tuple and each subsequent location n-tuple in the non-decreasing location n-tuple sequence into the tier that was added to the tier set immediately after the tier referenced by the rising tier counter when the upper bounding tier is not the most recently created tier in the tier set.

FIG. 2 shows that the method 200 can also include, when the current value of the rising tier counter does not reference the upper bounding tier, identifying 228 the first location n-tuple in the non-decreasing location n-tuple sequence that satisfies the following conditions (a “sequence next location n-tuple”): (i) the sequence next location n-tuple occurs subsequent to the sequence current location n-tuple in the non-decreasing location n-tuple sequence; and (ii) either the current value of the rising tier counter is a null value or the placement predicate tier for the sequence next location n-tuple (a “sequence next predicate tier”) was added to the tier set after the tier referenced by the current value of the rising tier counter.

Identifying 228 the sequence next location n-tuple can be implemented in multiple manners. One implementation can include linear probing—i.e. serially identifying the placement predicate tier for each location n-tuple subsequent to the sequence current location n-tuple in the non-decreasing location n-tuple sequence. A more efficient implementation can include use of binary search. Because of the monotonically non-decreasing tier property, binary search can be employed in identifying 228 the sequence next location n-tuple.

Binary search opens the possibility of correctly placing each of the location n-tuples in a non-decreasing location n-tuple sequence without the necessity of inspecting each of the location n-tuples in the sequence. Specifically, binary search can be employed to partition the non-decreasing location n-tuple sequence into sandwiched subsequences. That is, binary search can be employed to identify pairs of location n-tuples in the sequence that share the same placement predicate tier, such that the placement predicate tier sandwich property applies. Doing so also necessarily identifies the placement predicate tier for each of the other location n-tuples between the two location n-tuples in the sequence, without the necessity of inspecting these intervening location n-tuples.

FIG. 2 shows that the method 200 can also include determining 230 whether the current value of the rising tier counter is a null value.

FIG. 2 shows that the method 200 can also include placing 232 the sequence current location n-tuple and each location n-tuple between the sequence current location n-tuple and the sequence next location n-tuple in the non-decreasing location n-tuple sequence into the first-created tier when the current value of the rising tier counter is a null value.

FIG. 2 shows that the method 200 can also include placing 234 the sequence current location n-tuple and each location n-tuple between the sequence current location n-tuple and the sequence next location n-tuple in the non-decreasing location n-tuple sequence into the tier that added to the tier set immediately after the tier referenced by the rising tier counter when the current value of the rising tier counter is not a null value.

FIG. 2 shows that the method 200 can also include adjusting 236 the sequence location n-tuple counter so that it references the sequence next location n-tuple.

FIG. 2 shows that the method 200 can also include adjusting 238 the rising tier counter so that it references the sequence next predicate tier.

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Assume a tier set as follows:
tier 0: {{0, 0, 0, 0}, {0, 0, 0, 2}, {0, 0, 0, 4}, {0, 0, 0, 5}, {0, 0, 0, 6}, {0, 0, 4, 0}, {0, 0, 4, 2}, {0, 0, 4, 4}, {0, 0, 4, 5}, {0, 0, 4, 6}, {0, 5, 0, 0}, {0, 5, 0, 2}, {0, 5, 0, 4}, {0, 5, 0, 5}, {0, 5, 0, 6}, {0, 5, 4, 0}, {0, 5, 4, 2}, {0, 5, 4, 4}, {0, 5, 4, 5}, {0, 5, 4, 6}}
tier 1: {{1, 1, 1, 1}}
tier 2: {{2, 2, 2, 3}}

Assume a non-decreasing location n-tuple sequence as follows:
{{5, 5, 4, 0}, {5, 5, 4, 2}, {5, 5, 4, 4}, {5, 5, 4, 5}, {5, 5, 4, 6}}

Because it is determined 202 that the tier set is not empty, the last location n-tuple in the sequence ({5, 5, 4, 6}) is examined to determine 206 whether an upper bounding tier exists. Because it is determined that 206 an upper bounding tier (tier 2) exists, a rising tier counter is created 210.

The first location n-tuple in the sequence ({5, 5, 4, 0}) is examined to determine 212 whether a lower bounding tier exists. Because it is determined 212 that no lower bounding tier exists, the rising tier counter is nulled 214.

The sequence location n-tuple counter is created 218 and initialized to reference {5, 5, 4, 0}. Because it is determined 220 that the current value of the rising tier counter does not reference the upper bounding tier, the sequence next location n-tuple is identified 228 as {5, 5, 4, 2}, with tier 1 as the sequence next predicate tier.

Because it is determined 230 that the current value of the rising tier counter is a null value, {5, 5, 4, 0} is placed 232 into the first-created tier. The tier set might now be depicted as follows:
tier 0: {{0, 0, 0, 0}, {0, 0, 0, 2}, {0, 0, 0, 4}, {0, 0, 0, 5}, {0, 0, 0, 6}, {0, 0, 4, 0}, {0, 0, 4, 2}, {0, 0, 4, 4}, {0, 0, 4, 5}, {0, 0, 4, 6}, {0, 5, 0, 0}, {0, 5, 0, 2}, {0, 5, 0, 4}, {0, 5, 0, 5}, {0, 5, 0, 6}, {0, 5, 4, 0}, {0, 5, 4, 2}, {0, 5, 4, 4}, {0, 5, 4, 5}, {0, 5, 4, 6}, {5, 5, 4, 0}}
tier 1: {{1, 1, 1, 1}}
tier 2: {{2, 2, 2, 3}}

The sequence location n-tuple counter is adjusted 236 to reference {5, 5, 4, 2}. The rising tier counter is adjusted 238 to reference compactable tier 1.

Because it is determined 220 that the current value of the rising tier counter does not reference the upper bounding tier, the sequence next location n-tuple is identified 228 as {5, 5, 4, 4}, with tier 2 as the sequence next predicate tier.

Because it is determined 230 that the current value of the rising tier counter is a not null value, {5, 5, 4, 2} is placed 234 into tier 2. The tier set might now be depicted as follows:
tier 0: {{0, 0, 0, 0}, {0, 0, 0, 2}, {0, 0, 0, 4}, {0, 0, 0, 5}, {0, 0, 0, 6}, {0, 0, 4, 0}, {0, 0, 4, 2}, {0, 0, 4, 4}, {0, 0, 4, 5}, {0, 0, 4, 6}, {0, 5, 0, 0}, {0, 5, 0, 2}, {0, 5, 0, 4}, {0, 5, 0, 5}, {0, 5, 0, 6}, {0, 5, 4, 0}, {0, 5, 4, 2}, {0, 5, 4, 4}, {0, 5, 4, 5}, {0, 5, 4, 6}, {5, 5, 4, 0}}
tier 1: {{1, 1, 1, 1}}
tier 2: {{2, 2, 2, 3}, {5, 5, 4, 2}}

The sequence location n-tuple counter is adjusted 236 to reference {5, 5, 4, 4}. The rising tier counter is adjusted 238 to reference compactable tier 2.

Because it is determined 220 that the current value of the rising tier counter references the upper bounding tier and it is determined 222 that the upper bounding tier is the most recently created tier in the tier set, a new tier is created 224, {5, 5, 4, 4}, {5, 5, 4, 5} and {5, 5, 4, 6} are added to the newly-created tier and the newly-created tier is added to the tier set. The tier set might now be depicted as follows:
tier 0: {{0, 0, 0, 0}, {0, 0, 0, 2}, {0, 0, 0, 4}, {0, 0, 0, 5}, {0, 0, 0, 6}, {0, 0, 4, 0}, {0, 0, 4, 2}, {0, 0, 4, 4}, {0, 0, 4, 5}, {0, 0, 4, 6}, {0, 5, 0, 0}, {0, 5, 0, 2}, {0, 5, 0, 4}, {0, 5, 0, 5}, {0, 5, 0, 6}, {0, 5, 4, 0}, {0, 5, 4, 2}, {0, 5, 4, 4}, {0, 5, 4, 5}, {0, 5, 4, 6}, {5, 5, 4, 0}}
tier 1: {{1, 1, 1, 1}}
tier 2: {{2, 2, 2, 3}, {5, 5, 4, 2}}
tier 3: {{5, 5, 4, 4}, {5, 5, 4, 5}, {5, 5, 4, 6}}

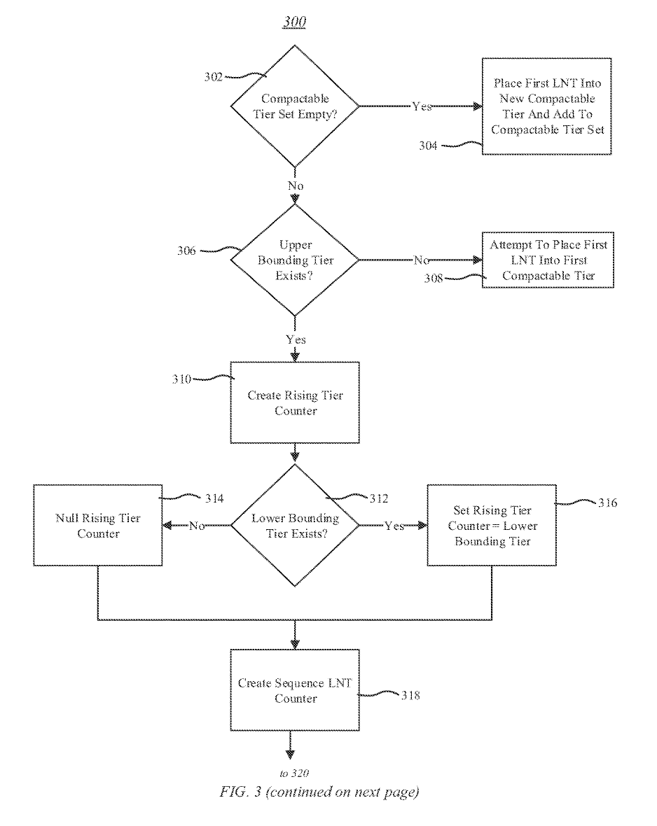

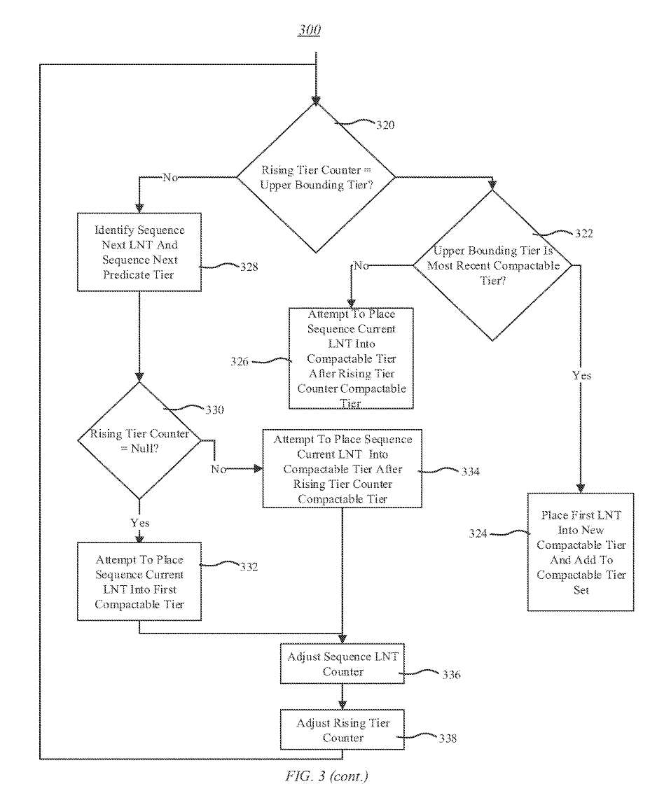

FIG. 3 is a flowchart illustrating a method 300 of placing one or more location n-tuples in a non-decreasing location n-tuple sequence into a compactable tier set.

FIG. 3 shows that the method 300 can include determining 302 whether the compactable tier set is empty.

FIG. 3 shows that the method 300 can also include creating 304 a new compactable tier, placing the first location n-tuple in the non-decreasing location n-tuple sequence into the newly-created compactable tier and adding the newly-created compactable tier to the compactable tier set when the compactable tier set is empty.

FIG. 3 shows that the method 300 can also include determining 306 whether an upper bounding tier exists in the compactable tier set when the compactable tier set is not empty.

FIG. 3 shows that the method 300 can also include attempting 308 to place the first location n-tuple in the non-decreasing location n-tuple sequence into the first-created compactable tier when an upper bounding tier does not exist in the compactable tier set.

If no upper bounding tier exists in the compactable tier set, all of the location n-tuples in the non-decreasing location n-tuple sequence must necessarily share the same potential placement compactable tier (i.e. the first-created compactable tier). When multiple successive location n-tuples in a non-decreasing location n-tuple sequence share the same potential placement compactable tier, it is unnecessary to attempt to place any other than the first such location n-tuple into the compactable tier set. Any attempt to place any location n-tuple subsequent to the first into the compactable tier set will fail due to an omission compaction. See application Ser. No. 15/263,200, previously incorporated, for further information regarding the definition of an “omission compaction.”

Notationally, this can be explained as follows. Assume that the potential placement compactable tier for a location n-tuple {x′₀, x′₁, . . . x′ₙ} in a non-decreasing location n-tuple sequence is compactable tier[m]. By the definition of a non-decreasing location n-tuple sequence, any location n-tuple {x″₀, x″₁, . . . x″ₙ} that occurs subsequent to {x′₀, x′₁, . . . x′ₙ} in the sequence satisfies the relationship that {x′₀, x′₁, . . . x′ₙ}≦{x″₀, x″₁, . . . x″ₙ}. Consequently, if the attempt to place {x′₀, x′₁, . . . x′ₙ} into compactable tier[m] succeeds, {x′₀, x′₁, . . . x′ₙ} will (once placed) constitute an existing smaller or equal location n-tuple with respect to {x″₀, x″₁, . . . x″ₙ}. Therefore, any attempt to also place {x″₀, x″₁, . . . x″ₙ} into compactable tier[m] will fail due to an omission compaction.

Alternatively, if {x′₀, x′₁, . . . x′ₙ} is not placed into compactable tier[m], this means that compactable tier[m] already contains an existing smaller or equal location n-tuple {x₀, x₁, . . . x_{n,}} such that {x₀, x₁, . . . xₙ}≦{x′₀, x′₁, . . . x′ₙ}. Thus, we see that {x₀, x₁, . . . xₙ}≦{x′₀, x′₁, . . . x′ₙ}≦{x″₀, x″₁, . . . x″ₙ} [symbol] {x₀, x₁, . . . xₙ}≦{x″₀, x″₁, . . . x″ₙ}. Hence, any attempt to place {x″₀, x″₁, . . . x″ₙ} into compactable tier[m] will fail due to an omission compaction.

More generally, we see that any attempt to place two location n-tuples into the same compactable tier when the first location n-tuple is smaller than or equal to the second location n-tuple will necessarily result in an omission compaction of the second location n-tuple (an “inevitable omission compaction”).

FIG. 3 shows that the method 300 can also include creating 310 a rising tier counter when an upper bounding tier exists in the compactable tier set.

FIG. 3 shows that the method 300 can also include determining 312 whether a lower bounding tier exists in the compactable tier set.

FIG. 3 shows that the method 300 can also include nulling 314 the rising tier counter when a lower bounding tier does not exist in the compactable tier set.

FIG. 3 shows that the method 300 can also include adjusting 316 the rising tier counter so that it references the lower bounding tier when a lower bounding tier exists in the compactable tier set.

FIG. 3 shows that the method 300 can also include creating 318 a sequence location n-tuple counter and initializing it to reference the first location n-tuple in the non-decreasing location n-tuple sequence.

FIG. 3 shows that the method 300 can also include determining 320 whether the current value of the rising tier counter references the upper bounding tier. The steps 320-338 are repeated (as applicable) until it is determined 320 that the current value of the rising tier counter references the upper bounding tier.

FIG. 3 shows that the method 300 can also include determining 322 whether the upper bounding tier is the most recently created compactable tier in the compactable tier set when the current value of the rising tier counter references the upper bounding tier.

FIG. 3 shows that the method 300 can also include creating 324 a new compactable tier, placing the sequence current location n-tuple into the newly-created compactable tier and adding the newly-created compactable tier to the compactable tier set when the upper bounding tier is the most recently created compactable tier in the compactable tier set.

FIG. 3 shows that the method 300 can also include attempting 326 to place the sequence current location n-tuple into the compactable tier that was added to the compactable tier set immediately after the compactable tier referenced by the rising tier counter when the upper bounding tier is not the most recently created compactable tier in the compactable tier set.

FIG. 3 shows that the method 300 can also include, when the current value of the rising tier counter does not reference the upper bounding tier, identifying 328 a sequence next location n-tuple and a sequence next predicate tier.

FIG. 3 shows that the method 300 can also include determining 330 whether the current value of the rising tier counter is a null value.

FIG. 3 shows that the method 300 can also include attempting 332 to place the sequence current location n-tuple into the first-created compactable tier when the current value of the rising tier counter is a null value.

FIG. 3 shows that the method 300 can also include attempting 334 to place the sequence current location n-tuple into the compactable tier that was added to the compactable tier set immediately after the compactable tier referenced by the rising tier counter when the current value of the rising tier counter is not a null value.

FIG. 3 shows that the method 300 can also include adjusting 336 the sequence location n-tuple counter so that it references the sequence next location n-tuple.

FIG. 3 shows that the method 300 can also include adjusting 338 the rising tier counter so that it references the sequence next predicate tier.

The following example is provided for illustrative purposes only and without intent or effect to limit the scope of the invention. It does not purport to illustrate all of the steps (either required or optional) nor every sub-part of, nor state nor condition applicable to, those steps (either required or optional) illustrated.

Assume a compactable tier set as follows:
compactable tier 0: {{0, 0, 0, 0}}
compactable tier 1: {{1, 1, 1, 1}}
compactable tier 2: {{2, 2, 2, 3}}

Assume a non-decreasing location n-tuple sequence as follows:
{{5, 5, 4, 0}, {5, 5, 4, 2}, {5, 5, 4, 4}, {5, 5, 4, 5}, {5, 5, 4, 6}}

Because it is determined 302 that the compactable tier set is not empty, the last location n-tuple in the sequence ({5, 5, 4, 6}) is examined to determine 306 whether an upper bounding tier exists in the compactable tier set. Because it is determined that 306 an upper bounding tier (compactable tier 2) exists, a rising tier counter is created 310.

The first location n-tuple in the sequence ({5, 5, 4, 0}) is examined to determine 312 whether a lower bounding tier exists. Because it is determined 312 that no lower bounding tier exists, the rising tier counter is nulled 314.

The sequence location n-tuple counter is created 318 and initialized to reference {5, 5, 4, 0}. Because it is determined 320 that the current value of the rising tier counter does not reference the upper bounding tier, the sequence next location n-tuple is identified 328 as {5, 5, 4, 2}, with compactable tier 1 as the sequence next predicate tier.

Because it is determined 330 that the current value of the rising tier counter is a null value, an attempt 332 is made to place the sequence current location n-tuple ({5, 5, 4, 0}) into the first-created compactable tier. The attempt fails. The sequence location n-tuple counter is adjusted 336 to reference {5, 5, 4, 2}. The rising tier counter is adjusted 338 to reference compactable tier 1.

Because it is determined 320 that the current value of the rising tier counter does not reference the upper bounding tier, the sequence next location n-tuple is identified 328 as {5, 5, 4, 4}, with compactable tier 2 as the sequence next predicate tier.

Because it is determined 330 that the current value of the rising tier counter is a not null value, an attempt 334 is made to place the sequence current location n-tuple ({5, 5, 4, 2}) into compactable tier 2. The attempt succeeds and the compactable tier set might now be depicted as follows:
compactable tier 0: {{0, 0, 0, 0}}
compactable tier 1: {{1, 1, 1, 1}}
compactable tier 2: {{2, 2, 2, 3}, {5, 5, 4, 2}}

The sequence location n-tuple counter is adjusted 336 to reference {5, 5, 4, 4}. The rising tier counter is adjusted 338 to reference compactable tier 2.

Because it is determined 320 that the current value of the rising tier counter references the upper bounding tier and it is determined 322 that the upper bounding tier is the most recently created compactable tier in the compactable tier set, a new compactable tier is created 324, {5, 5, 4, 4} is added to the newly-created compactable tier and the newly-created compactable tier is added to the compactable tier set. The compactable tier set might now be depicted as follows:
compactable tier 0: {{0, 0, 0, 0}}
compactable tier 1: {{1, 1, 1, 1}}
compactable tier 2: {{2, 2, 2, 3}, {5, 5, 4, 2}}
compactable tier 3: {{5, 5, 4, 4}}

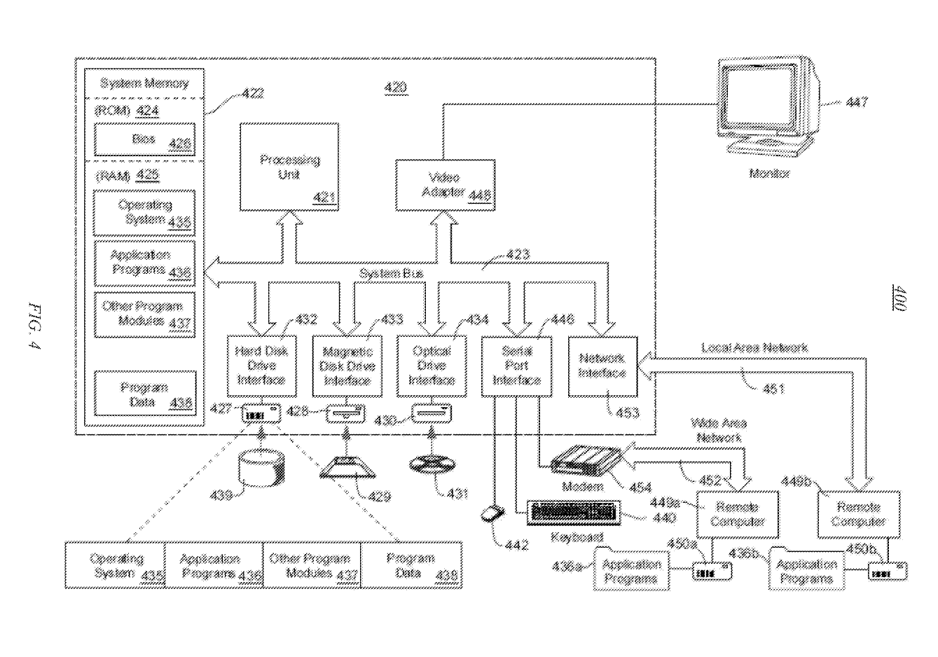

FIG. 4, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating a non-decreasing location n-tuple sequence, the method comprising:
obtaining two or more component sequences;
selecting one of the component sequences as the primary sort-order component sequence;
populating a locations index for at least one component sequence other than the primary sort-order component sequence;
adding each locations index to a locations index set;
creating one or more tier sets;
creating a primary sort-order item counter;
generating one or more primary sort-order non-decreasing location n-tuples.

2. The method of claim 1 wherein generating one or more primary sort-order non-decreasing location n-tuples includes:
when each locations index in the locations index set contains an associated locations list associated with the primary sort-order cursor item and the locations index set contains more than one locations index:
selecting one of the associated locations lists as the increasing component value locations list;
identifying one or more permutations that may be generated by selecting exactly one value from each of the associated locations lists other than the increasing component value locations list, together with the values from the increasing component value locations list taken successively one at a time;
adding the values in each identified permutation to a newly-created primary sort-order non-decreasing location n-tuple; and
adding the current value of the primary sort-order item counter to each primary sort-order non-decreasing location n-tuple.

3. The method of claim 1 wherein generating one or more primary sort-order non-decreasing location n-tuples includes:
when each locations index in the locations index set contains an associated locations list associated with the primary sort-order cursor item and the locations index set contains exactly one locations index:
selecting the associated locations list as the increasing component value locations list;
identifying one or more permutations that may be generated by selecting the values from the increasing component value locations list taken successively one at a time;
adding the values in each identified permutation to a newly-created primary sort-order non-decreasing location n-tuple; and
adding the current value of the primary sort-order item counter to each primary sort order non-decreasing location n-tuple.

4. The method of claim 1 further comprising:
placing one or more of the primary sort-order non-decreasing location n-tuples into one or more of the tier sets.

5. The method of claim 4 wherein placing one or more of the primary sort-order non-decreasing location n-tuples into one or more of the tier sets includes use of binary search.

6. The method of claim 4 wherein placing one or more of the primary sort-order non-decreasing location n-tuples into one or more of the tier sets includes use of bounding location n-tuples.

7. The method of claim 4 wherein placing one or more of the primary sort-order non-decreasing location n-tuples into one or more of the tier sets includes partitioning the primary sort-order non-decreasing location n-tuples into sandwiched subsequences.

8. The method of claim 1 further comprising:
adjusting the primary sort-order item counter.

9. A method of placing one or more location n-tuples in a non-decreasing location n-tuple sequence into a tier set, the method comprising:
when no upper bounding tier exists in the tier set:
placing each of the location n-tuples in the non-decreasing location n-tuple sequence into the first-created tier in the tier set.

10. The method of claim 9, further comprising:
when an upper bounding tier exists in the tier set:
creating a sequence location n-tuple counter; and
creating a rising tier counter.

11. The method of claim 10, further comprising:
when no lower bounding tier exists in the tier set:
nulling the rising tier counter; and
when a lower bounding tier exists in the tier set:
adjusting the rising tier counter so that it references the lower bounding tier.

12. The method of claim 11, further comprising:
when the current value of the rising tier counter references the upper bounding tier and the upper bounding tier is the most recently created tier in the tier set:
creating a new tier;
placing the sequence current location n-tuple into the newly-created tier;
placing each location n-tuple subsequent to the sequence current location n-tuple in the non-decreasing location n-tuple sequence into the newly-created tier;
adding the newly-created tier to the tier set;
when the current value of the rising tier counter references the upper bounding tier and the upper bounding tier is not the most recently created tier in the tier set:
placing the sequence current location n-tuple into the tier that was added to the tier set immediately after the tier referenced by the rising tier counter; and
placing each location n-tuple subsequent to the sequence current location n-tuple in the non-decreasing location n-tuple sequence into the tier that was added to the tier set immediately after the tier referenced by the rising tier counter.

13. The method of claim 11, further comprising:
when the current value of the rising tier counter does not reference the upper bounding tier:
identifying a sequence next location n-tuple; and
identifying a sequence next predicate tier.

14. The method of claim 13, wherein identifying a sequence next location n-tuple includes use of binary search.

15. The method of claim 13, further comprising:
when the current value of the rising tier counter is a null value:
placing the sequence current location n-tuple into the first-created tier in the tier set; and
placing each location n-tuple between the sequence current location n-tuple and the sequence next location n-tuple in the non-decreasing location n-tuple sequence into the first-created tier in the tier set.

16. The method of claim 13, further comprising:
when the current value of the rising tier counter is not a null value:
placing the sequence current location n-tuple into the tier that was added to the tier set immediately after the tier referenced by the rising tier counter; and
placing each location n-tuple between the sequence current location n-tuple and the sequence next location n-tuple in the non-decreasing location n-tuple sequence into the tier that was added to the tier set immediately after the tier referenced by the rising tier counter.

17. The method of claim 13, further comprising:
adjusting the sequence location n-tuple counter so that it references the sequence next location n-tuple; and
adjusting the rising tier counter so that it references the sequence next predicate tier.

18. A method of placing one or more location n-tuples in a non-decreasing location n-tuple sequence into a compactable tier set, the method comprising:
when no upper bounding tier exists in the compactable tier set:
placing each of the location n-tuples in the non-decreasing location n-tuple sequence into the first-created compactable tier in the compactable tier set.

19. The method of claim 18, further comprising:
when an upper bounding tier exists in the compactable tier set:
creating a sequence location n-tuple counter; and
creating a rising tier counter.

20. The method of claim 19, further comprising:
when no lower bounding tier exists in the compactable tier set:
nulling the rising tier counter; and
when a lower bounding tier exists in the compactable tier set:
adjusting the rising tier counter so that it references the lower bounding tier.

21. The method of claim 20, further comprising:
when the current value of the rising tier counter references the upper bounding tier and the upper bounding tier is the most recently created compactable tier in the compactable tier set:
creating a new compactable tier;
placing the sequence current location n-tuple into the newly-created compactable tier;
adding the newly-created compactable tier to the compactable tier set; and
when the current value of the rising tier counter references the upper bounding tier and the upper bounding tier is not the most recently created compactable tier in the compactable tier set:
placing the sequence current location n-tuple into the compactable tier that was added to the compactable tier set immediately after the compactable tier referenced by the rising tier counter.

22. The method of claim 20, further comprising:
when the current value of the rising tier counter does not reference the upper bounding tier:
identifying a sequence next location n-tuple; and
identifying a sequence next predicate tier.

23. The method of claim 22, wherein identifying a sequence next location n-tuple includes use of binary search.

24. The method of claim 22, further comprising:
when the current value of the rising tier counter is a null value:
attempting to place the sequence current location n-tuple into the first-created compactable tier in the compactable tier set; and
when the current value of the rising tier counter is not a null value:
attempting to place the sequence current location n-tuple into the compactable tier that was added to the compactable tier set immediately after the compactable tier referenced by the rising tier counter.

25. The method of claim 22, further comprising:
adjusting the sequence location n-tuple counter so that it references the sequence next location n-tuple; and
adjusting the rising tier counter so that it references the sequence next predicate tier.
